(19) United States
(12) Patent Application Publication
(10) Pub. No.: US 2008/0117304 A1
(43) Pub. Date: May 22, 2008

(54) Camera

(75) Inventor: Hisaki Koyama, Tokyo (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 11/984,418

(22) Filed: Nov. 16, 2007

(30) Foreign Application Priority Data
Nov. 22, 2006 (JP) 2006-315784

(51) Int. Cl. H04N 5/228

(52) U.S. Cl. 348/208.4

(57) ABSTRACT

To provide a camera having improved efficiency. A camera is provided with a fitting portion to which a lens barrel is detachably fitted, and a first driving portion capable of driving an aperture portion included in the lens barrel. The first driving portion can be switched between an actuable state in which it is actuated in response to an input and drive the aperture portion and an actuation-restricted state to restrict the actuation. The first driving portion is brought into the actuation-restricted state when the lens barrel fitted to the fitting portion is equipped with a second driving portion capable of driving the aperture portion.

The disclosure of the following priority application is herein incorporated by reference: Japanese Patent Application No. 2006-315784 filed on Nov. 22, 2006.

### BACKGROUND OF THE INVENTION

1. Field of the Invention

The present invention relates to a camera.

2. Description of Related Art

Among lens-interchangeable type cameras to which a lens barrel is detachable, those comprising an aperture driving device for driving an aperture portion provided for the lens barrel are known (for example, refer to Japanese Unexamined Utility Model Publication No. Hei 6-47943).

The prior art aperture driving device for a camera has a problem in that the device always operates in response to any input from a release switch or the like even if the lens barrel itself is equipped with an actuator which drives an aperture portion, thus leading to unsatisfactory efficiency.

### SUMMARY OF THE INVENTION

The object of the present invention is to provide a camera with improved efficiency.

The invention resolves the above-mentioned problem by the following solution.

According to the present invention, a camera comprising: a fitting portion to which a lens barrel is detachably fitted; and a first driving portion to drive an aperture portion included in the lens barrel, wherein the first driving portion can be switched between an actuable state in which it is actuated in response to an input and drives the aperture portion, and an actuation-restricted state in which the actuation is restricted.

In the camera according to the invention, the first driving portion may be brought into the actuation-restricted state when the lens barrel fitted to the fitting portion is equipped with a second driving portion capable of driving the aperture portion.

In the camera according to the invention may further comprise a communication portion to communicate with the lens barrel fitted in the fitting portion; and a control portion to control the first driving portion on the basis of output of the communication portion.

The camera according to the invention may further comprise a detection portion to detect whether the lens barrel fitted to the fitting portion is equipped with the second driving portion; and a control portion to control the first driving portion based on output of the detection portion.

The camera according to the invention may further comprise an input portion capable of selecting the state of the first driving portion from the actuable state or the actuation-restricted state, and inputting the selected state.

As mentioned above, according to the camera of the present invention, it is possible to switch the first driving portion between actuation and non-actuation, thus improving the efficiency.

### BRIEF DESCRIPTION OF THE DRAWINGS

FIG. 1 is a block diagram showing a configuration of the camera system according to the first embodiment.

FIG. 2 is a flowchart showing control performed by a camera CPU provided to the camera system of FIG. 1.

FIG. 3 is a block diagram showing a configuration of the camera system according to the second embodiment.

### DETAILED DESCRIPTION OF THE INVENTION

### The First Embodiment

A camera system including a camera main body portion which is the first embodiment of a camera of the present invention will now be explained with reference to the drawings.

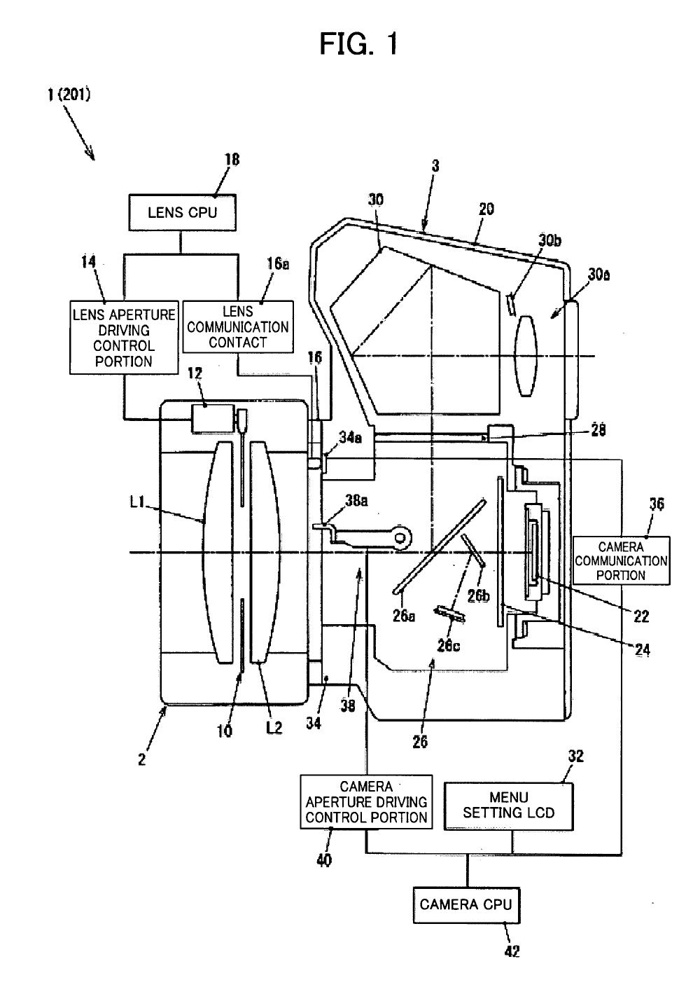

FIG. 1 is a block diagram showing a configuration of the camera system according to the first embodiment.

The camera system 1 of the first embodiment is a single-lens reflex camera system of lens-interchangeable type. An interchangeable lens 2 can be detachably fitted to a camera main body portion 3, for example via a bayonet mount portion.

In this camera system 1, for example a plurality of kinds of interchangeable lenses having common lens-side mounting portions is prepared for the camera main body portion 3. A user of the camera system 1 can select any interchangeable lens in accordance with the purpose of shooting or the like and mount it to the camera main body portion 3.

The interchangeable lens 2 shown in FIG. 1 is a lens barrel accommodating a plurality of lens units including a first lens unit L1 and a second lens unit L2. It should be noted that other lens units than the first lens unit L1 and the second lens unit L2 are omitted from the illustration. The first lens unit L1 and the second lens unit 2 are arranged in this order from the object side to the image side along the optical axis.

This interchangeable lens 2 is a so-called CPU lens that can communicate shooting information such as focal length to the camera main body portion 3 with an electrical signal. The interchangeable lens 2 comprises an aperture portion 10, a lens aperture driving portion 12, a lens aperture driving control portion 14, lens-side mount portion 16 and a lens CPU 18.

The aperture portion 10 is disposed between the first lens unit L1 and the second lens unit L2 for controlling the amount of light of a light flux passing between the first lens unit L1 and the second lens unit L2. The aperture portion 10 is, for example, a well-known iris diaphragm in which a plurality of aperture blades, not shown, an aperture blade driving ring for causing these aperture blades to engage, and so on are combined.

The lens aperture driving portion 12 is a second driving portion including, e.g. an actuator such as a stepping motor for driving the aperture blade driving ring mentioned above. The aperture portion 10 changes the aperture of an opening formed by the plurality of aperture blades and thereby varies the amount of light of the light flux if the aperture blade driving ring is driven by the lens aperture driving portion 12.

The lens aperture driving control portion 14 is a part for controlling the driving of the stepping motor provided for the lens aperture driving portion 12 on the basis of a signal output from a camera CPU 42 described later.

The lens-side mount portion 16 is a part of a bayonet mount provided on an image side in the direction of the optical axis of the interchangeable lens 2.

This lens-side mount portion 16 is equipped with a lens communication contact 16a.

The lens communication contact 16a is an electrical contact exposed to the image side in the direction of the optical axis of the interchangeable lens 2. When the interchangeable lens 2 is mounted to the camera main body portion 3, the lens communication contact 16a is brought into contact with a camera communication contact 34a provided in the camera main body portion 3, described later. In this way, in the camera system 1, the camera main body portion 3 and the interchangeable lens 2 are connected electrically, and the camera main body portion 3 and interchangeable lens 2 are enabled to transmit/receive various kinds of information such as a signal for AF control or a signal for AE control via their respective mutual communication contacts.

The lens CPU 18 is a part for generally controlling components constituting the interchangeable lens 2 including the above-mentioned aperture driving control portion 14.

The camera main body portion 3 comprises a camera body 20, an image pickup device 22, a shutter unit 24, a mirror unit 26, a finder screen 28, a prism 30, an LCD 32 for setting menus (LCD 32), a camera-side mount portion 34, a camera communication portion 36, a camera aperture driving portion 38, a camera aperture driving control portion 40 and a camera CPU 42.

The camera body 20 is an enclosure of the camera main body portion 3 accommodating therein the image pickup device 22 and the mirror unit 26 and so on (described later). The camera body 20 is formed from, for example, a synthetic resin material or a metallic material such as magnesium alloy.

The image pickup device 22 is a photoelectric conversion element for converting object image light imaged by a shooting optical system provided in the interchangeable lens 2 into an electrical signal. The image pickup device 22 is disposed in an area on a rear side (photographer's side) inside the camera body 20.

The shutter unit 24 is situated on the object side of the image pickup device 22. The shutter unit 24 comprises a front curtain and a rear curtain which are both driven in accordance with an input of a release switch, not shown. The camera system 1 exposes the image light passing through an image pickup optical system onto a pickup plane of the pickup device for an exposure period of time predetermined by the camera CPU 42 (described later) which controls the driving timings of the front and rear curtains.

The mirror unit 26 is situated inside the camera body 20 on an object side along the optical axis, closer to the object than the shutter unit 24, and comprises a main mirror 26a and a sub mirror 26b.

The main mirror 26a is a mirror reflecting the light passing through the image pickup optical system toward the prism 30 mentioned later. This main mirror 26a is a so-called half mirror, and is intended to transmit part of the light.

The main mirror 26a is situated with, for example, 45 degrees inclination of its reflective surface with respect to the optical axis. The main mirror 26a is a so-called quick return mirror that turns about an axis provided in its end in response to an input from the release switch at the time of shooting and withdraws to a position where its reflective surface is substantially in parallel with the optical axis.

The sub mirror 26b is a mirror that bends the path of light passing through the main mirror 26a to a direction opposite to the main mirror 26a and reflects the light to a range measuring portion 26c placed below the main mirror 26a.

The finder screen 28 is a screen for forming an image from the light reflected by the main mirror 26a and is situated above the main mirror 26a.

The prism 30 is an optical element for making an image formed on the finder screen 28 an upright image and guiding it to an ocular optical system 30a provided on a rear surface of the camera body 20. Between the prism 30 and the ocular optical system 30a, there is disposed a light measuring device 30b including a light measuring element.

The LCD 32 is a liquid crystal display device provided on a rear surface of the camera body 20, for example. This LCD 32 is an input portion capable of displaying a menu window from which the photographer set the shutter speed, ISO sensitivity, aperture value and so on.

The camera-side mount portion 34 consists of a bayonet portion provided at a front surface of the camera body 20 (surface portion opposed to the object at the time of shooting) and so on. The interchangeable lens 2 is fitted to the camera main body portion 3 via this camera-side mount portion 34, and the camera-side mount portion 34 functions as a fitting part.

The camera-side mount portion 34 has a camera communication contact 34a.

The camera communication contact 34a is an electrical contact point that is brought into contact with the previously-mentioned lens communication contact 16a in a situation where the interchangeable lens 2 is fitted to the camera main body portion 3. The camera communication contact 34a is exposed to the image side in the optical axis of the camera-side mount portion 34.

The camera communication portion 36 is a part for carrying out communication of various kinds of information with a lens communication portion (not shown) provided for the interchangeable lens 2 via the lens communication contact 16a and the camera communication contact 34a.

The various kinds of interchangeable lenses capable of being fitted to the camera main body portion 3 all comprise an aperture portion having a function similar to the aperture portion 10 provided to the interchangeable lens 2 shown in FIG. 1.

These interchangeable lenses have a lens aperture driving portion 12 as the interchangeable lens 2 shown in FIG. 1, and include two types, that is, a type (built-in actuator type) in which the lens aperture driving portion 12 drives the aperture portion 10 in accordance with a signal input from the camera CPU 42, and a type in which no lens aperture driving portion 12 such as an actuator is provided.

The camera aperture driving portion 38 is a first driving part for driving an aperture portion of an interchangeable lens of a type not having the above-mentioned lens aperture driving portion 12 (hereinafter, referred to as an interchangeable lens 4 in the explanation). It should be noted that the interchangeable lens 4 is omitted from the illustration.

The camera aperture driving portion 38 has a lever 38a provided protruding toward the object side in a direction of the optical axis from an end portion of the camera-side mount portion 34. An aperture portion of the interchangeable lens 4 has an engaging portion (not shown) for mechanically engaging with the lever 38a in a situation where the interchangeable lens 4 is fitted to the camera main body portion 3.

This engaging portion is connected to an aperture blade driving ring provided in the aperture portion, and the aperture blades of the aperture portion of the interchangeable lens 4 are engaged and driven when the lever 38a of the camera main body 3 is driven.

The camera aperture driving portion 38 has a solenoid, a motor, a sensor and so on (all not shown) for driving the lever 38a. The lever 38a is actuated in cooperation with the main mirror 26a, for example at the time of shooting. The aperture portions of the interchangeable lenses 2 and 4 are opened at the time of framing, and when the main mirror is moved (mirrored up) to a withdrawn position at the time of exposure to light, in cooperation therewith the aperture blades are driven so as to decrease the aperture of the aperture portion 10 (to reduce the amount of light).

The camera aperture driving control portion 40 is a part for controlling a solenoid, a motor and so on provided in the camera aperture driving portion 38, and is configured to control the drive amount of the motor and the like in accordance with the set aperture size value.

The camera CPU 42 is a part for generally controlling components including the image pickup device 22, a camera aperture driving control portion 40 and so on provided in the camera main body portion 3.

This camera CPU 42 determines whether an interchangeable lens (the interchangeable lens 2 or 4) fitted to the camera-side mount portion 34 has a lens aperture driving portion 12 in dependence upon the output from the camera communication portion 36, and switches the camera aperture driving portion 38 between actuation and non-actuation.

More specifically, in the case of the interchangeable lens 4 being mounted to the camera main body portion 3, the camera CPU 42 controls the camera aperture driving control portion 40 to bring the camera aperture driving portion 38 into an actuable state, so as to drive the lever 38a in cooperation with the main mirror 26a.

In contrast to this, in the case of the interchangeable lens 2 being mounted to the camera main body portion 3, the camera CPU 42 controls the camera aperture driving control portion 40 to bring the camera aperture driving portion 38 into an actuation-restricted state, so that the lever 38a is not actuated.

Hereinafter, actuation control of the camera aperture driving portion 38 performed by the camera CPU 42 will be described using a flowchart.

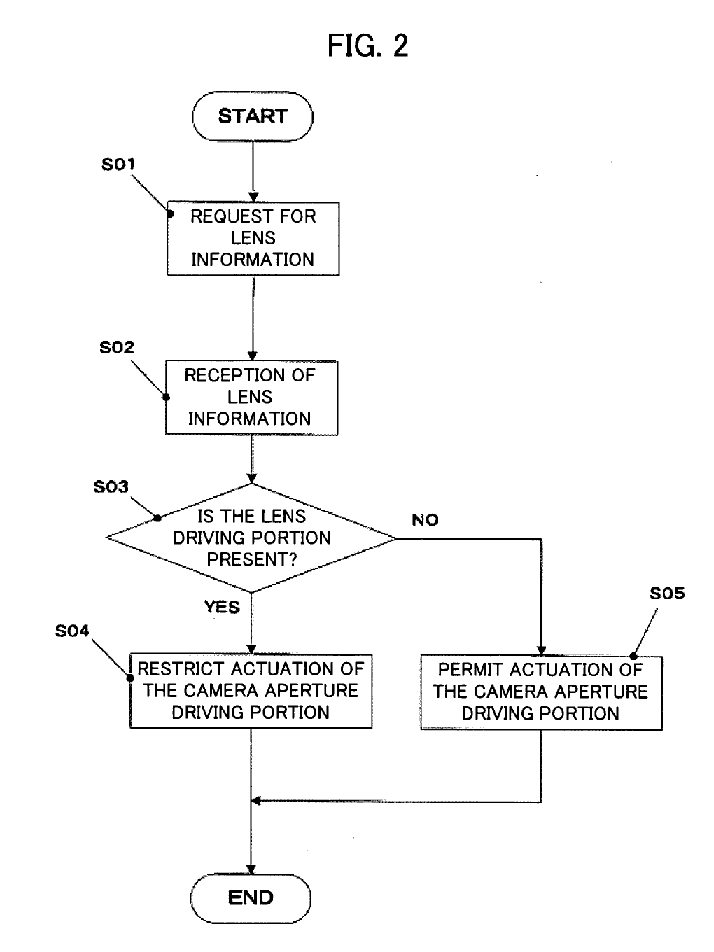

FIG. 2 is a flowchart showing control performed by the camera CPU.

Next, an explanation will be given for each step.

### (Step S01: Request for Lens Information)

For example, when the photographer activates a release switch, then the camera CPU 42 issues a signal for inquiring shooting information such as the focal length of a zoom lens to the mounted interchangeable lens (the interchangeable lens 2 or 4). In addition to this shooting information, the camera CPU 42 also inquires whether or not the interchangeable lens is equipped with a lens aperture driving portion 12.

### (Step S02: Reception of Lens Information)

The lens CPU 18 issues a signal including the shooting information and information capable of determining whether or not the lens has a lens aperture driving portion 12 in response to the inquiring signal from the camera CPU 42.

The camera CPU 42 receives the signal from the lens CPU 18 via the camera communication portion 36 and proceeds to Step S03.

### (Step S03: Determination of Presence or Absence of a Lens Aperture Portion)

The camera CPU 42 determines whether or not this interchangeable lens is equipped with a lens aperture driving portion 12 based on the output from the lens CPU 18. As a result, when the fitted interchangeable lens is equipped with a lens aperture driving portion 12, that is, when the interchangeable lens 2 shown in FIG. 2 is fitted thereto, the flow goes to Step S04.

When the fitted interchangeable lens is not equipped with a lens aperture driving portion 12, that is, when the interchangeable lens 4 is fitted thereto, the flow goes to step S05.

### (Step S04: Control of a Camera Aperture Driving Portion with Restricted Actuation)

The camera CPU 42 performs control to restrict actuation of the camera aperture driving portion 38.

More specifically, the camera CPU 42 executes control to stop supplying electricity to the solenoid, motor, sensor and so on provided in the camera aperture driving portion 38, thereby to restrict the driving of the lever 38a of the camera aperture driving portion 38.

### (Step S05: Control of a Camera Aperture Driving Portion with Permitted Actuation)

The camera CPU 42 performs control to permit the supply of electricity to the solenoid, motor, sensor and so on provided in the camera aperture driving portion 38. In this way, the camera aperture driving portion 38 can drive the lever 38a in cooperation with the release switch.

As described above, the camera system 1 of this embodiment can offer the following advantages.

(1) If an interchangeable lens fitted to the camera main body portion 3 is any of a built-in actuator type, that is, if an aperture diameter of the aperture portion 10 of the interchangeable lens 2 can be changed without actuating the camera aperture driving portion 38 provided in the camera main body portion 3, then the camera aperture driving portion 38 is not supplied with electricity, thus reducing power consumption and improving efficiency.

(2) In the camera main body portion 3, the lever 38a of the camera aperture driving portion 38 is not actuated when the interchangeable lens 2 is fitted thereto, thus preventing occurrence of the actuation sound of the lever 38a. Therefore, the photographer can comfortably operate the camera.

(3) Since the camera main body portion 3 is configured not to actuate the mechanically driven lever 38a, abrasion does not occur, for example in a bearing for supporting the lever 38a or the like. In this way, it is possible to avoid occurrence of dust due to the abrasion, adhesion of the dust to an image pickup surface and so on.

### The Second Embodiment

Next, a camera system 101 including a camera main body portion 103 that is the second embodiment of the camera of the present invention is explained. It should be noted in the second embodiment herein and the third embodiment described later that functionally similar components to the first embodiment described above are given the same reference symbols or common ending reference symbols, and overlapping descriptions and figures are appropriately omitted.

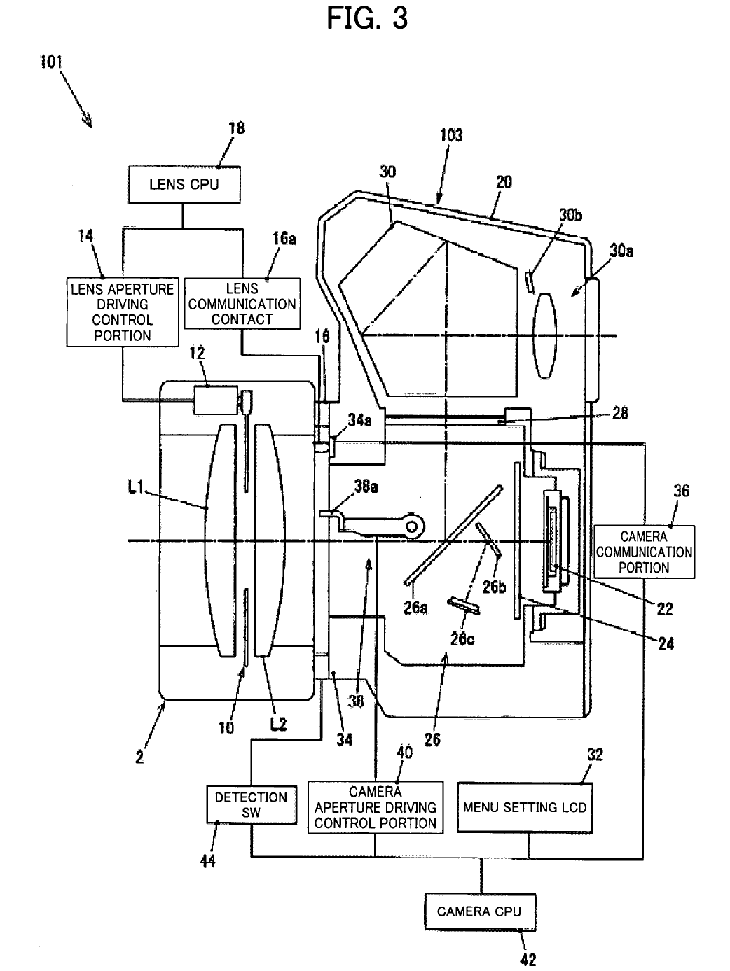

FIG. 3 is a block diagram showing a configuration of a camera system of the second embodiment.

A camera system 101 of the second embodiment is also configured to selectively mount various kinds of interchangeable lenses on a camera main body portion 103 as with the camera system 1 of The first embodiment. The camera system 101 controls the driving of a camera aperture driving portion 38 in dependence on whether or not these interchangeable lenses are equipped with a lens aperture driving portion 12.

The camera main body portion 103 is equipped with a detection switch 44.

This detection switch 44 is provided, for example, at a location other than the camera communication contact 34a in a camera-side mount portion 34 of the camera main body portion 103.

The forms in a position where the interchangeable lens contacts the detection switch 44 when setting the lens to the camera main body portion 103 are different between the interchangeable lens 2 with the lens aperture driving portion 12 and the interchangeable lens 4 without a lens aperture driving portion 12.

The camera main body portion 103 determines whether or not the mounted interchangeable lens is equipped with the lens aperture driving portion 12 by the camera CPU 42 recognizing a difference in shape between the mount portions of the interchangeable lenses 2 and 4 through the detection switch 44.

The camera system 101 of the second embodiment has a dedicated detection switch 44 capable of determining whether or not an interchangeable lens (the interchangeable lens 2 or 4) is equipped with a lens aperture driving portion 12. By doing so, even if the fitted interchangeable lens is not equipped with a lens communication contact 16a used for AF control and the like, for example, then it is possible to control the actuation of the camera aperture driving portion 38 reliably.

### The Third Embodiment

Now a camera system 201 equipped with a camera main body portion that is the third embodiment of a camera according to the present invention is explained. It should be noted that the third embodiment is described using FIG. 1 because the configuration of the camera system 201 is much the same as the camera system 1 of the first embodiment shown in FIG. 1.

The camera system 201 of the third embodiment is intended to manually select actuation or non-actuation (ON or OFF) of the camera aperture driving portion 38 provided on the camera main body portion 3 by input of the photographer to the camera CPU 42 using a menu screen displayed on the LCD 32 for setting menus provided on the camera main body portion 3.

In the camera system 201 of the third embodiment, the camera CPU 42 controls the camera aperture driving control portion 40 so as to restrict actuation of the camera aperture driving portion 38 when a selection is made to deactivate the camera aperture driving portion 38 of the camera main body portion 3 using the menu screen.

In this way, when a built-in actuator type interchangeable lens 2 is mounted thereto, it is possible to restrict actuation of the camera aperture driving portion 38 of the camera main body portion 3, thus leading to a reduction of power consumption.

### (Modifications)

The camera of the present invention is not limited to the embodiments described so far; many different modifications and variations are possible, and these also fall within the technical scope of the invention.

(1) Although the camera system of the first embodiment issues a signal capable of determining whether or not the interchangeable lens is equipped with a lens aperture driving portion in response to an inquiry signal from the camera CPU, the way to determine the kind of the interchangeable lens is not limited to this, and can also be as follows.

For instance, one may arrange the embodiment to preserve data about interchangeable lenses manufactured in the past in a memory device or the like of the camera main body portion while acquiring information capable of identifying the kind of fitted interchangeable lens via communication, and to determine whether or not the fitted interchangeable lens is equipped with a lens aperture driving portion by checking the acquired information against the preserved data.

(2) The camera of the embodiments is a digital camera, but the invention is not limited to this and is applicable to film cameras using a silver-halide film in an image pickup portion.

1. A camera comprising:
a fitting portion to which a lens barrel is detachably fitted; and
a first driving portion to drive an aperture portion included in the lens barrel,
wherein the first driving portion can be switched between an actuable state in which it is actuated in response to an input and drives the aperture portion, and an actuation-restricted state in which the actuation is restricted.

2. The camera according to claim 1,
wherein the first driving portion is brought into the actuation-restricted state when the lens barrel fitted to the fitting portion is equipped with a second driving portion capable of driving the aperture portion.

3. The camera according to claim 2, further comprising:
a communication portion to communicate with the lens barrel fitted in the fitting portion; and
a control portion to control the first driving portion on the basis of output of the communication portion.

4. The camera according to claim 2, further comprising:
a detection portion to detect whether the lens barrel fitted to the fitting portion is equipped with the second driving portion; and
a control portion to control the first driving portion based on output of the detection portion.

5. The camera according to claim 1, further comprising:
an input portion capable of selecting the state of the first driving portion from the actuable state or the actuation-restricted state, and inputting the selected state.

6. The camera according to claim 2, further comprising:
an input portion capable of selecting the state of the first driving portion from the actuable state or the actuation-restricted state, and inputting the selected state.

7. (canceled)
